(19) United States
(12) Patent Application Publication
(10) Pub. No.: US 2010/0188332 A1
(43) Pub. Date: Jul. 29, 2010

(54) THIN-FILM TRANSISTOR IMAGER

(75) Inventor: Timothy James Orsley, San Jose, CA (US)

Correspondence Address: Kathy Manke;Avago Technologies Limited, 4380 Ziegler Road, Fort Collins, CO, 80525, US

(73) Assignee: Avago Technologies ECBU IP (Singapore) Pte. Ltd., Singapore (SG)

(21) Appl. No.: 12/359,191

(22) Filed: Jan. 23, 2009

(51) Int. Cl. G09G 5/08

(52) U.S. Cl. 345/157

(57) ABSTRACT

An optical input device for finger input on an electronic computing device. The optical input device includes a thin-film transistor (TFT) imager and an integrated circuit (IC). The TFT imager includes a protective layer, a substrate, and a TFT array. The protective layer has a finger contact surface. The TFT array includes photo-sensitive thin-film transistors disposed on a surface of the substrate, between the substrate and the protective layer. The TFT array generates image signals corresponding to physical features of a user's finger in contact with the finger contact surface of the protective layer. The integrated circuit is coupled to the TFT imager. The integrated circuit processes the image signals from the TFT array.

### BACKGROUND

Optical finger navigation (OFN) is currently available for cursor control in handheld devices such as ultra-mobile personal computers (PCs) and mobile phones, as well as other types of devices. Optical finger navigation is generally based on obtaining several images (i.e., frames) of a user's finger sequentially over time, correlating the images with one another, and determining movement of the finger over time based on frame-to-frame changes in the images.

Conventional optical finger navigation devices typically have an imaging stack which includes an image sensor and imaging optics. The image sensor is often built into an integrated circuit that processes the signals produced by the image sensor. In other words, the pixels of the image sensor are built into the same semiconductor die that contains the digital logic that controls the pixels. Since the image sensor and the integrated circuit are beneath the imaging optics, the thickness of the imaging stack can be disadvantageous, especially when compared with the thicknesses of competing capacitive sensors that are used for fingerprint recognition.

Also, conventional optical finger navigation devices typically have a small imaging array that is too small to image a sufficient finger area for fingerprint recognition. For example, many optical finger navigation devices use a 20×20 array of picture elements (pixels), with each pixel having a pitch (i.e., width) of about 50 microns, for a total footprint of about 1×1 mm for the pixel array. In order to image sufficient area for fingerprint recognition, a conventional optical finger navigation device should have a much larger footprint of, for example, 10×10 mm. However, implementing this size of image sensor would also increase the overall size of the semiconductor die on which the image sensor is located, which would result in a large, thick imaging stack that is unsuitable for many applications. Hence, conventional optical finger navigation devices are not considered to be suitable for fingerprint recognition applications because of these size constraints, especially when compared with relatively thin capacitive sensors that are typically implemented for fingerprint recognition.

Conventional capacitive sensors use a series of capacitive elements to detect the fingerprint ridges or other features of a user's finger. The logic to process the signals from the capacitive sensors are typically within the same plane on the same semiconductor die. However, capacitive sensors have a fundamental weakness due to susceptibility to damage from electrostatic discharge (ESD) because of the need for the sensor to be in close proximity to the finger being imaged, which could carry static electricity. Also, capacitive sensors can have a relatively high production cost when manufactured with sufficient size to perform fingerprint recognition.

Thus, there are inherent conflicts among several factors when determining whether to use conventional optical navigation devices or capacitive sensors for fingerprint recognition in ultra-mobile PCs and mobile phones which have physical size, cost, and robustness constraints. Conventional optical finger navigation devices are relatively thick compared with conventional capacitive sensors. Conventional capacitive sensors suffer from susceptibility to damage from ESD. Both types of devices can be expensive to manufacture in sufficient size for fingerprint navigation. The significance of each of these factors can be magnified when considered within the context of ultra-mobile PCs and mobile phones which currently follow trends of becoming smaller and less expensive.

### SUMMARY

Embodiments of an optical input device for authentication and navigation are described. In one embodiment, the optical input device is an optical input device for finger input on an electronic computing device. An embodiment of the optical input device includes a thin-film transistor (TFT) imager and a separate integrated circuit (IC). The TFT imager includes a protective layer, a substrate, and a TFT array. The protective layer has a finger contact surface. The TFT array includes photo-sensitive thin-film transistors disposed on a surface of the substrate, between the substrate and the protective layer. The TFT array generates image signals corresponding to physical features of a user's finger in contact with the finger contact surface of the protective layer. The integrated circuit is coupled to the TFT imager. The integrated circuit processes the image signals from the TFT array. Other embodiments of the optical input device are also described.

Embodiments of an electronic computing device with optical input functionality are also described. An embodiment of the electronic computing device includes a finger contact surface of a protective layer. The electronic computing device also includes a TFT imager aligned with the finger contact surface. The TFT imager generates images of at least a portion of a user's finger in contact with the finger contact surface. The electronic computing device also includes an integrated circuit coupled to the TFT imager. The integrated circuit is located remotely from the TFT imager such that a footprint of the integrated circuit does not overlap with a footprint of the TFT imager. Other embodiments of the electronic computing device are also described.

Embodiments of a method are also described. In one embodiment, the method is a method for operating an optical input device. An embodiment of the method includes generating a plurality of image signals representative of light which reflects off of a physical feature of a user's finger in contact with a finger contact surface of a TFT imager. The method also includes processing the image signals to generate and output an output signal based on a comparison of at least some of the image signals to other finger representation signals. Other embodiments of the method are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic block diagram of one embodiment of an electronic computing device which uses thin-film transistor (TFT) technology for optical navigation and fingerprint recognition.

FIG. 2 depicts a schematic sectional block diagram of a more detailed embodiment of the imaging circuit of the electronic computing device of FIG. 1.

FIG. 3A depicts a schematic diagram of one embodiment of the TFT array of the TFT imager shown in FIG. 2.

FIG. 3B depicts a schematic diagram of one embodiment of a rectangular TFT array of the TFT imager shown in FIG. 2.

FIGS. 3C-E depict schematic diagrams of one embodiment of a non-rectangular TFT array of the TFT imager shown in FIG. 2.

FIG. 4A depicts a schematic diagram of one embodiment of the capacitive array of FIG. 2 surrounding the rectangular TFT array shown in FIG. 3B.

FIG. 4B depicts a schematic diagram of one embodiment of the capacitive array of FIG. 2 surrounding the non-rectangular TFT array shown in FIG. 3C.

FIG. 5A depicts one embodiment of a TFT imager that has a substantially square finger contact surface for both fingerprint recognition and finger navigation in multiple directions.

FIG. 5B depicts one embodiment of a TFT imager that has a thin rectangular finger contact surface primarily for both fingerprint recognition and finger navigation in a single direction.

FIG. 6 depicts a schematic block diagram of a more detailed embodiment of the integrated circuit of the electronic computing device of FIG. 2.

FIG. 7 depicts a schematic flow chart diagram of one embodiment of a method for operating an optical input device which uses TFT imaging technology for both fingerprint recognition and finger navigation.

Throughout the description, similar reference numbers may be used to identify similar elements.

### DETAILED DESCRIPTION

While many embodiments are described herein, at least some of the described embodiments implement a finger imaging device which utilizes thin-film transistor (TFT) technology for the optical imaging functions of the finger imager. By implementing a finger imaging device using TFT technology, the finger imaging device can be more robust than conventional capacitive fingerprint sensors. Additionally, the TFT technology allows embodiments of the finger imaging device to achieve a comparable thickness of conventional capacitive sensors. In particular, embodiments of the finger imaging device can decouple, or remotely locate, the digital logic that processes signals from the TFT imager, so that the digital logic is not in a stack with the TFT imager. Also, embodiments of the finger imaging device may be manufactured with lower costs than either conventional optical finger navigation devices or capacitive sensors. For convenience, the finger imaging device is generally referred to herein as an optical input device.

Embodiments of the optical input device are suitable for use in small and ultra-mobile electronic computing devices. For example, the optical input device may be implemented in mobile PCs, mobile phones, personal digital assistants (PDAs), and so forth. Depending on the type of device and functionality that is implemented, the size and/or shape of the optical input device may facilitate different types of functionality. For instance, an optical input device with a small, rectangular finger contact surface may be used for fingerprint recognition by scanning a user's finger as the user slides the finger across the finger contact surface of the optical input device. In another example, an optical input device with a larger, square finger contact surface may be used for both fingerprint recognition and for finger navigation to allow the user to control cursor movements based on finger movements in one or more directions.

For further understanding of various embodiments, the following detailed description and appended drawings provide examples of configurations and functionality which can be implemented within the scope of the optical input device.

Additionally, other embodiments of the optical input device may be achieved in other specific forms that may be understood within the context of this disclosure. For example, the components and features of the described embodiments may be arranged in a variety of configurations to achieve the same or similar functionality. Hence, the described and illustrated embodiments are illustrative examples, and additional embodiments are understood to be within the scope of this disclosure.

Furthermore, the described features, advantages, and characteristics of the described embodiments may be combined in any suitable manner in one or more embodiments. Also, certain embodiments can be practiced without one or more of the specific features or advantages of a particular embodiment. In other instances, additional features and advantages may be recognized in certain embodiments that may not be present in all embodiments. Hence, references throughout this specification to “one embodiment,” “an embodiment,” or similar language means that a particular feature, structure, or characteristic described in connection with the indicated embodiment is included in a specific embodiment, but is not necessarily included in all embodiments.

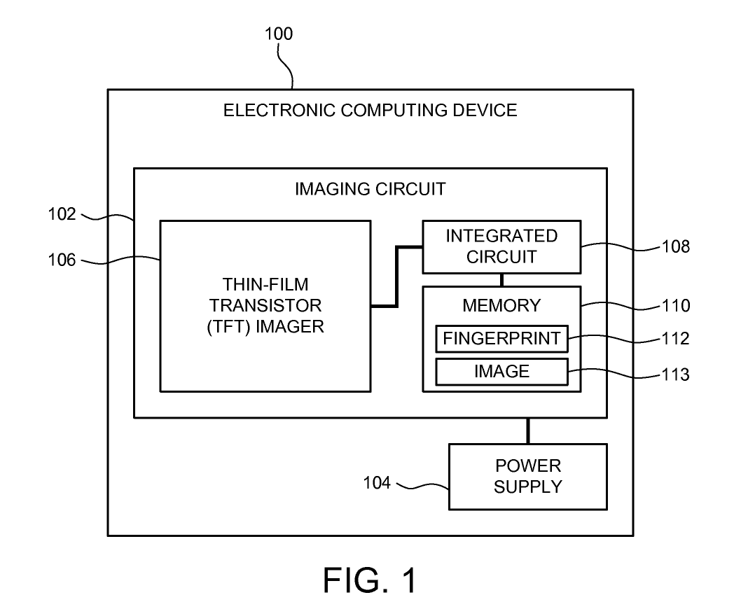

FIG. 1 depicts a schematic block diagram of one embodiment of an 30 electronic computing device 100 which uses thin-film transistor (TFT) technology for optical navigation and fingerprint recognition. In general, the illustrated electronic computing device 100 is representative of many different types of devices such as ultra-mobile PCs, mobile phones, and so forth. Although the electronic computing device 100 is shown and described with specific components and functionality, other embodiments of the electronic computing device 100 may include fewer or more components to achieve less or more functionality. For instance, the electronic computing device 100 may include cellular transmission circuitry (not shown) to facilitate cellular telephone transmissions, in the case of a mobile phone. Additionally, embodiments of the electronic computing device 100 may include various input components, output components, or other circuitry or components, depending on the type of device that is implemented.

The illustrated electronic computing device 100 includes an imaging circuit 102 and a power supply 104. In one embodiment, the power supply 104 is a conventional battery which supplies power at a particular voltage, for example, to the imaging circuit 102. The power supply 104 also may supply power to other components within the electronic computing device 100. In an alternative embodiment, the power supply 104 may be external to the electronic computing device 100.

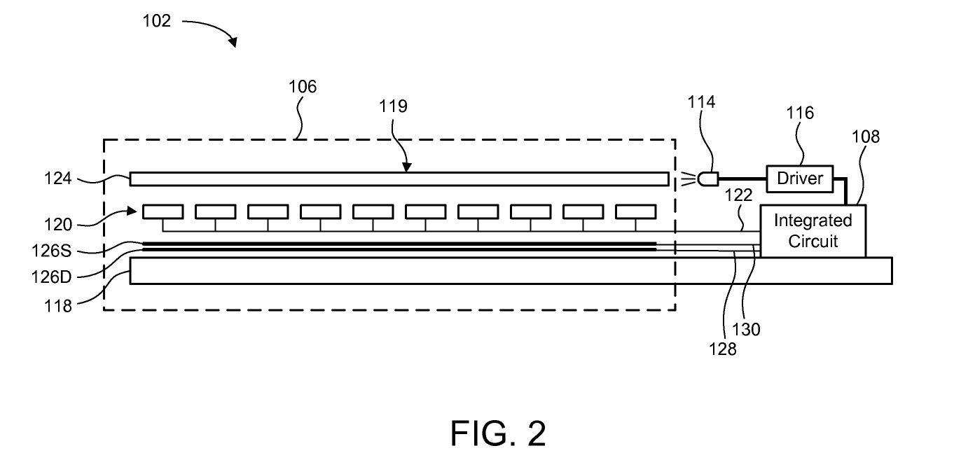

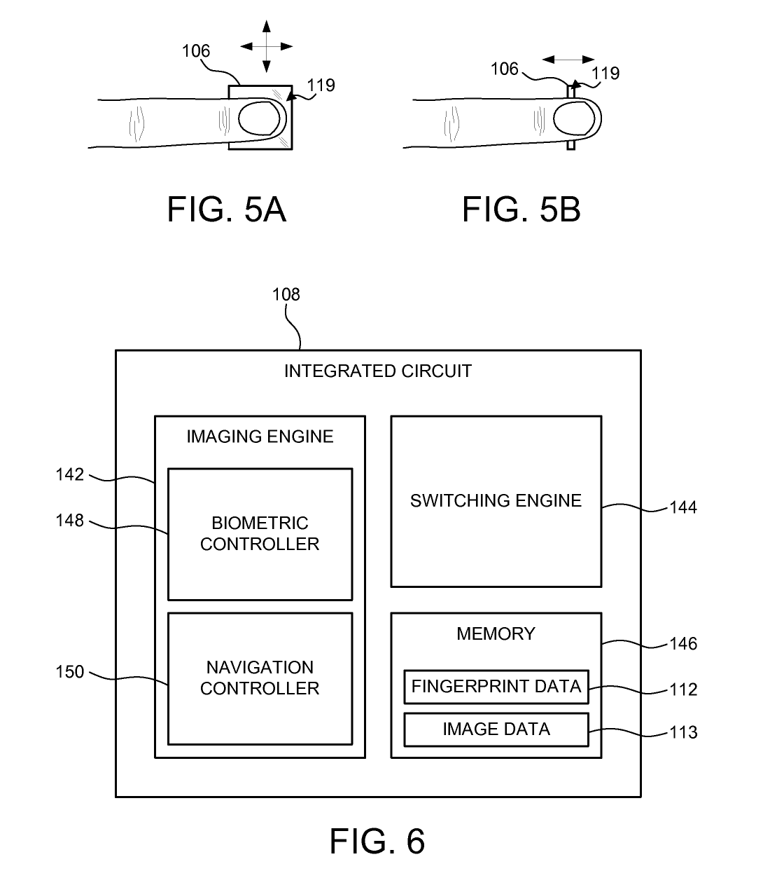

The imaging circuit 102 is arranged to obtain images of a user's finger (refer to FIGS. 5A and 5B) or another type of input device (e.g., a stylus). The illustrated imaging circuit 102 includes a TFT imager 106, an integrated circuit 108, and a memory device 1 10. An example of the TFT imager 106 is shown in FIG. 2 and described in more detail below. Similarly, an example of the integrated circuit 108 is shown in FIG. 6 and described in more detail below.

In general, the TFT imager 106 is used to obtain images of the user's finger. In one embodiment, the TFT imager 106 can obtain the images of the user's finger when the user's finger is in contact with a finger contact surface (refer to FIG. 2) of the TFT imager 106. The TFT imager 106 can obtain the images as the finger moves across the finger contact surface or when the finger is at rest (i.e., not moving) on the finger contact surface. The TFT imager 106 sends image signals, which are representative of the physical features of the user's finger, to the integrated circuit 108.

The integrated circuit 108 processes the image signals from the TFT imager 106. Although the integrated circuit 108 may perform various types of processing on the image signals, and specific examples of different types of processing modes are described below in conjunction with the description of FIG. 6, an overview of some of the processing modes may be useful to understand the functionality of the imaging circuit 102. In general, embodiments of the integrated circuit 108 may perform at least two types of processing using the image signals corresponding to the physical features of the user's finger.

In one embodiment, the integrated circuit 108 includes functionality to implement a biometric processing mode, or biometric mode. In the biometric mode, the integrated circuit 108 may use the image signals to stitch together a larger image and identify physical features of the user's finger and determine if the physical features match a specific user's profile. As one example, the integrated circuit may compare the identified physical features to fingerprint data 112 stored in the memory device 110. The fingerprint data 112 may include a digital fingerprint representation which indicates one or more known physical features of a known user. Thus, if the identified physical features of the imaged finger match the fingerprint data 112 stored in the memory device 110, then the integrated circuit indicates that there is a biometric match between the imaged fingerprint and the stored fingerprint. In this way, the imaging circuit 102 can perform biometric evaluations. Depending on the result of such evaluations, the integrated circuit may generate a fingerprint recognition signal and transmit the fingerprint recognition signal to an additional processing unit (not shown) within the electronic computing device 100. The additional processing unit may use the fingerprint recognition signal, for example, to grant or deny authorization to the user for access to certain data and/or applications.

In another embodiment, the integrated circuit 108 includes functionality to implement a navigation processing mode, or navigation mode. In the navigation mode, the integrated circuit 108 uses the image signals to generate one or more navigation signals indicative of the relative movement of the user's finger on the TFT imager 106. The integrated circuit 108 may compare new finger input data with prior finger input data to determine the relative movement. In one embodiment, the prior finger input data may be stored as image data 113 in the memory 110.

In this way, frames of image information captured by the TFT imager 106 may be used by the integrated circuit 108 within the navigation mode. A frame of image information includes a set of roughly simultaneously captured values for the thin-film transistors in the TFT imager 106. Image frames captured by the TFT imager 106 include data that represents features of the user's finger on the finger contact surface of the TFT imager 106. The rate of image frame capture and tracking resolution can be programmable. In an embodiment, the image frame capture rate ranges up to about 2,300 frames per second with a resolution of about 500 counts per inch (cpi). Although some examples of frame capture rates and resolutions are provided, different frame capture rates and resolutions are contemplated.

The integrated circuit 108 compares successive image frames from the TFT imager 106 to determine the movement of image features between frames. In particular, a tracking engine (not shown) within the integrated circuit 108 determines movement by correlating common features that exist in successive image frames generated by the TFT imager 106. The movement between image frames is expressed in terms of movement vectors in, for example, X and Y directions (e.g., Δx and Δy). The movement vectors are then used to determine the movement of the user's finger relative to the TFT imager 106. More detailed descriptions of examples of navigation sensor movement tracking techniques are provided in U.S. Pat. No. 5,644,139, entitled NAVIGATION TECHNIQUE FOR DETECTING MOVEMENT OF NAVIGATION SENSORS RELATIVE TO AN OBJECT, and U.S. Pat. No. 6,222,174, entitled METHOD OF CORRELATING IMMEDIATELY ACQUIRED AND PREVIOUSLY STORED FEATURE INFORMATION FOR MOTION SENSING, both of which are incorporated by reference herein.

The integrated circuit 108 may then transmit one or more navigation signals to the additional processor within the electronic computing device 100. Examples of types of signals transmitted from the integrated circuit 108 of the imaging circuit 102 to the additional processor include channel quadrature signals based on Δx and Δy relative displacement values. These signals, or other signals, may be indicative of a movement of the user's finger relative to the TFT imager 106. Other embodiments may use other types of navigation signals.

FIG. 2 depicts a schematic sectional block diagram of a more detailed embodiment of the imaging circuit 102 of the electronic computing device 100 of FIG. 1. Embodiments of the imaging circuit 102 are also referred to herein as optical input devices. The illustrated imaging circuit 102 includes the TFT imager 106 and the integrated circuit 108. The imaging circuit 102 also includes an illumination source 114 and a driver 116. The illustrated TFT imager 106 includes a substrate 118, a TFT array 120 which is coupled to the integrated circuit by a signal communication channel 122, a protective layer 124 which has a finger contact surface 119, and a capacitive array 126 (including 126D and 126S) which is coupled to the integrated circuit 108 by a drive channel 128 and a sense channel 130. Although the TFT array 120 and the capacitive array 126 are shown in exploded view, some embodiments of the TFT imager 106 include the TFT array 120 and the capacitive array 126 disposed together on the same surface of the substrate 118. Other embodiments of the imaging circuit 102 may include fewer or more components, or different arrangements, to implement less or more functionality.

In one embodiment, the substrate 118 of the TFT imager 106 is a substantially transparent substrate such as glass. Alternatively, the substrate 118 may be a non-transparent material. Individual thin-film transistors are deposited or otherwise applied in an array to the front side of the substrate 118 (i.e., toward the finger contact surface 119). In one embodiment, the TFT array 120 includes thin-film transistors that have a relatively high photo-sensitivity. One example of a thin-film transistor that has a high photo-sensitivity is a hydrogenated amorphous silicon thin-film transistor (a-Si:H TFT). In the optical input device 102 described herein, the high photo-sensitivity is used to implement the TFT imager 106 in order to generate image signals corresponding to light which reflects off of physical features of a user's finger.

In one embodiment, the protective layer 124 is substantially transparent. The illumination source 114 generates light to illuminate the protective layer 124. In particular, the illumination source 114 emits light into the substantially transparent protective layer 124 to internally illuminate the substantially transparent protective layer 124 as a light guide. In one embodiment, the illumination source 114 is a light emitting diode (LED), in which case the integrated circuit 108 may control the driver 116 which drives the LED. In another embodiment, the illumination source 114 may be a laser such as a vertical cavity surface emitting laser (VCSEL). Alternatively, the illumination source 114 may be another type light source.

In the absence of a user's finger on the finger contact surface 119 of the protective layer 124, the light that enters the protective layer 124 tends to stay within the protective layer 124 due to total internal reflection (TIR), particularly at the finger contact surface 119 and the opposite surface adjacent to the TFT array 120. When a finger or other object makes contact with the finger contact surface 119, the contact interrupts the TIR and disperses the light. In particular, light disperses at the ridges of the user's fingerprint, but not at the valleys. This dispersion of light at the ridges forms light patterns that are detectable by the TFT array 120 on the opposite side of the protective layer 124, allowing the TFT array 120 to generate image signals corresponding to the light pattern generated by the ridges of the user's fingerprint. In some embodiments, the protective layer 124 is relatively thin, so that diffusion (i.e., scattering) of the light reflecting off of features of the user's finger is limited to reduce cross-talk at the pixels. For example, one embodiment of the protective layer 124 is about half the thickness of a pixel width (e.g., about 25 μm for a 50 μm pixel pitch). Other embodiments may use other thicknesses for the protective layer 124, depending on the electrostatic discharge (ESD) susceptibility of the protective layer 124, which increases as the thickness of the protective layer 124 decreases.

The TFT array 120 transmits the image signals to the integrated circuit 108 via the signal communication channel 122. The imaging circuit 102 also may include an analog-to-digital converter (ADC) to convert the image signals into digital form. In some embodiments, the signal communication channel 122 includes a separate channel for each row or column of thin-film transistors within the TFT array 120. The length of each signal communication channel 122 from the TFT array 120 to the integrated circuit 108 depends on the location of the integrated circuit 108 relative to the TFT array 120. In one embodiment, the integrated circuit 108 is remotely located from the TFT array 120 so that the footprint of the integrated circuit 108 does not overlap with (i.e., is decoupled from) the footprint of the TFT array 120. In other words, the integrated circuit 108 is neither stacked in alignment with nor located adjacent to the TFT array 120, so that the thickness of the TFT imager 106 can be relatively thin and compact. In one embodiment, the integrated circuit 108 is bonded to the substrate 118, on the same side as the TFT array 120. The integrated circuit 108 may be bonded to the substrate 118 using chip-on-glass mounting similar to conventional mounting of LCD row and column drivers. Other embodiments may locate the integrated circuit 108 in another remote location from the TFT array 120.

By decoupling the footprint of the integrated circuit 108 from the footprint of the TFT array 120, it is possible to inexpensively implement embodiments of a relatively large (200×200 pixels) TFT array 120 with sufficient density to facilitate both finger navigation and non-swipe fingerprint recognition. The line routing and pin count for a TFT array 120 with sufficient density may depend on the specific configuration of particular arrangements of the TFT array 120, as well as the relative location of the integrated circuit 108.

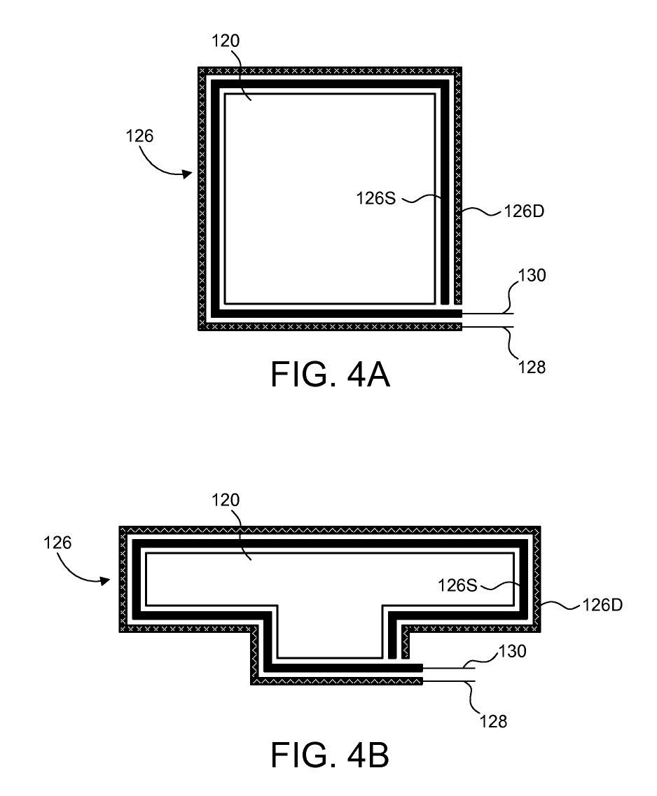

In some embodiments, the integrated circuit 108 also may include functionality to control when the TFT array 120 generates image signals. Since the TFT array 120 is sensitive to ambient light, as well as reflected light from a user's finger, it is possible that ambient light may be imaged in the absence of a user's finger at the finger contact surface 119 of the protective layer 124. Therefore, some embodiments include functionality to control the TFT array 120 so that image signals are only generated when a user's finger is in contact with the finger contact surface 119 of the protective layer 124. In a specific embodiment, the capacitive array 126 includes capacitive elements (refer to FIGS. 4A and 4B) to generate a sense signal in response to placement of the user's finger in contact with or otherwise within a detectable proximity of the TFT imager 106. In response to the sense signal, the integrated circuit 108 can turn on and off the TFT array 120. Similarly, the integrated circuit 108 may turn on and off the illumination source 114 or other components of the imaging circuit 102. In one embodiment, the integrated circuit 108 compares the sense signal to a threshold and controls the TFT array 120 accordingly. In some embodiments, the integrated circuit 108 drives some of the capacitive elements of the capacitive array 126 on a continuous or intermittent basis using a drive signal on the drive channel 128. The sense signal is detected by the integrated circuit 108 via the sense channel 130.

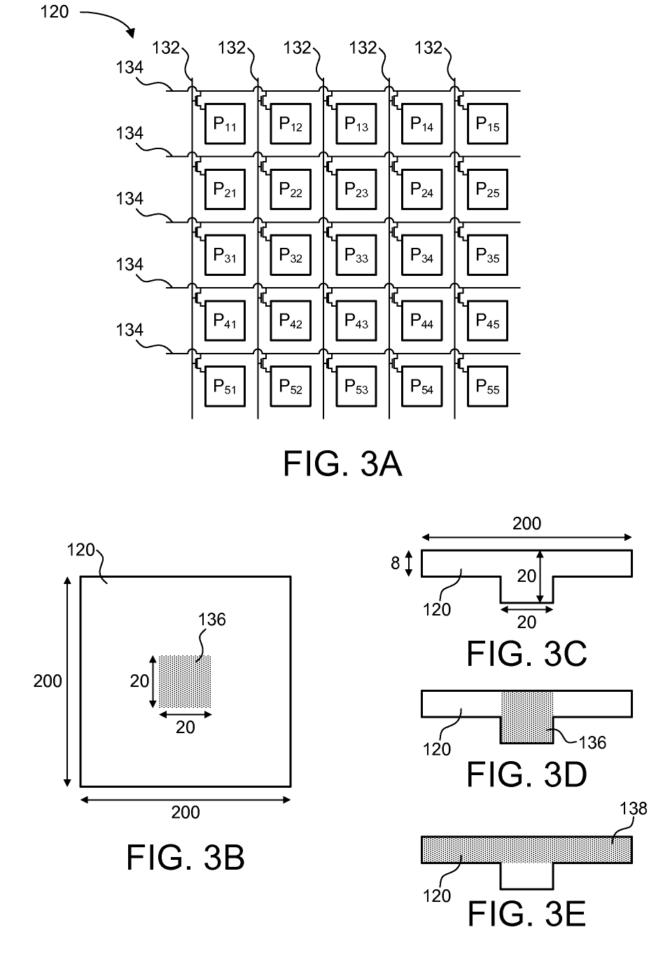

FIG. 3A depicts a schematic diagram of one embodiment of the TFT array 120 of the TFT imager 106 shown in FIG. 2. The illustrated TFT array 120 includes a plurality of individual pixels, designated together as P₁₁ through P₅₅. In the depicted embodiment, each pixel includes a conductive plate and a transistor. Although a specific number of pixels are shown, other embodiments may have fewer or more pixels. As one example, a square TFT array 120 may include an arrangement of about 200×200 pixels (refer to FIG. 3B). As another example, a thin rectangular TFT array 120 may include an arrangement of about 200×8 pixels. Other embodiments may have a different number and/or arrangement of pixels, including non-rectangular arrangements (refer to FIGS. 3C-E).

In the illustrated embodiment, the TFT array 120 also includes a plurality of drive channels 132 and a plurality of sense channels 134. Each drive channel 132 drives a column of pixels, and each sense channel 134 senses a row of pixels. During operation, a single drive channel 132 is energized to drive a single column of pixels, while the remaining drive channels are allowed to float. Since all of the rows are tied to ground (not shown), light incident on the energized pixels can be read out for each row in the energized column of pixels. Over time, the entire array of pixels can be scanned column by column (or row by row, in an opposite configuration) based on which column (or row) is energized at a time. In other embodiments, the number of drive and sense channels 132 and 134 relative to the number of pixels may be more or less. For example, each pixel may have a separate sense channel 134 in some embodiments. Additionally, other embodiments of the TFT array 120 may use other types of thin-film transistors.

FIG. 3B depicts a schematic diagram of one embodiment of a rectangular TFT array 120 of the TFT imager 106 shown in FIG. 2. More specifically, the illustrated TFT array 120 is a square TFT array. As one example, the TFT array 120 includes a 200×200 array of TFT pixels. Other embodiments may have fewer or more pixels. By using a relatively large array of about 200×200 pixels, it may be possible to obtain a fingerprint image without swiping the finger across the finger contact surface 119. Rather, the user may simply place a finger on the finger contact surface 119, and the TFT array 120 can obtain a static image of all or a sufficient part of the finger for fingerprint recognition.

The pixels of the 200×200 array also may be used for finger navigation. In some embodiments, all of the pixels in the TFT array 120 may be used to obtain images of the user's finger in the navigation mode. Alternatively, a subset of the pixels in the TFT array 120 may be used for finger navigation. For example, in one embodiment, the navigation mode may use a 20×20 subset 136 of pixels of the TFT array 120 for finger navigation. Other embodiments may use another rectangular or non-rectangular subset of pixels for finger navigation. Additionally, the subset 136 may be centered or located at another location within the TFT array 120.

FIGS. 3C-E depict schematic diagrams of one embodiment of a non-rectangular TFT array 120 of the TFT imager 106 shown in FIG. 2. In contrast to the rectangular arrangement shown in FIG. 3B, the TFT array 120 of FIG. 3C is non-rectangular. As one example, the non-rectangular TFT array 120 includes two overlapping pixel subsets 136 and 138, designated as navigation and recognition pixels, respectively. As shown in FIG. 3D, the navigation pixel subset 136 includes a 20×20 arrangement of pixels in the TFT array 120 for the navigation mode. As shown in FIG. 3E, the recognition pixel subset 138 includes a 200×8 arrangement of pixels in the TFT array 120 for the finger recognition mode. In this embodiment, the finger recognition mode may rely on stitching together images of the user's finger as the user's finger moves across the recognition pixel subset 138 of the TFT array 120. Other embodiments may use other arrangements. Additionally, some embodiments may have a different number or percentage of overlapping pixels which are common to both the navigation pixel subset 136 and the recognition pixel subset 138.

FIG. 4A depicts a schematic diagram of one embodiment of the capacitive array 126 of FIG. 2 surrounding the rectangular TFT array 120 shown in FIG. 3B. The illustrated capacitive array 126 includes a plurality of capacitive elements with at least one sense element 126S and at least one drive element 126D. For simplicity, the sense and drive elements 126S and 126D are arranged in a single lines which outline the rectangular TFT array 120. Although the sense and drive elements 126S and 126D are shown as not being connected in a full loop around the TFT array 120 (i.e., each line has a connected end and an unconnected end), some embodiments may implement one or more capacitive elements that connect in a full loop around the TFT array 120. For example, the sense element 126S, which is located closest to the TFT array 120, may connect in a full loop around the TFT array 120.

The sense element 126S is coupled to a single sense channel 130, and the drive element is coupled to a single drive channel 128. A single sense channel 130 and a single drive channel 128 may be used, even if the capacitive array 126 includes multiple sense elements 126S and/or multiple drive elements 126D. In one embodiment, the drive element 126D is driven with a square wave, and the sense element 126S senses mutual capacitive coupling. Thus, a user's finger in contact with the finger contact surface 119, or within a short distance of the finger contact surface 119, disrupts the mutual capacitive coupling and can be detected by the integrated circuit 108. Other embodiments may use other numbers and/or arrangements of capacitive elements, as well as different numbers and/or arrangements of drive and sense channels 128 and 130.

Also, in some embodiments, the sense element 126S and the drive element 126D are located in the same layer as the TFT array 120 on the front side of the substrate 118, between the substrate 118 and the protective layer 124. Alternatively, the capacitive elements may be located in another layer, or the capacitive elements may be located in the same layer, but disposed on the back side of the protective layer 124, rather than on the front side of the substrate 118. Other embodiments may use other capacitive element configurations.

FIG. 4B depicts a schematic diagram of one embodiment of the capacitive array 126 of FIG. 2 surrounding the non-rectangular TFT array shown 120 in FIG. 3C. Although the layout of the sense and drive elements 126S and 126D is slightly different from the layout shown in FIG. 4A, the functionality of the sense and drive elements 126S and 126D shown in FIG. 4B is substantially similar as described above.

FIG. 5A depicts one embodiment of a TFT imager 106 that has a substantially square finger contact surface 119 for both fingerprint recognition and finger navigation in multiple directions. Using this configuration, the imaging circuit 102 can image a sufficient area of the user's finger to perform both fingerprint recognition and finger navigation. Additionally, the finger navigation can be performed in several directions, as shown by the arrows.

FIG. 5B depicts one embodiment of a TFT imager 106 that has a thin rectangular finger contact surface 119 primarily for both fingerprint recognition and finger navigation in a single direction. Using this configuration, the imaging circuit 102 can image a sufficient area of the user's finger, as the finger moves across the finger contact surface 119 in at least one direction, to perform both fingerprint recognition and finger navigation, in the direction shown by the arrows. In some embodiments, it may be possible to use this configuration to perform at least limited finger navigation in multiple directions, similar to the configuration shown in FIG. 5A and described above.

FIG. 6 depicts a schematic block diagram of a more detailed embodiment of the integrated circuit 108 of the electronic computing device 100 of FIG. 2. The illustrated integrated circuit 108 includes several logic blocks, which may be implemented, for example, in hardware logic gates. In particular, the integrated circuit 108 includes an imaging engine 142, a switching engine 144, and a memory 146. The imaging engine 142 includes a biometric controller 148 and a navigation controller 150. In some embodiments, the memory 146 stores the fingerprint data 112 and/or the image data 113 described above with reference to FIG. 1. Although the integrated circuit 108 is shown and described with specific components and functionality, other embodiments of the integrated circuit 108 may include fewer or more components to achieve less or more functionality.

In general, the imaging engine 142 processes the image signals from the TFT array 120 to generate digital representations of the physical features of the user's finger. Depending on the mode in which the integrated circuit 108 operates, the integrated circuit 108 may perform biometric processing or navigation processing on the image signals from the TFT array 120. For example, the integrated circuit 108 may operate by default in the biometric mode at startup until fingerprint recognition is successful, and then the integrated circuit 108 may operate in the navigation mode.

In the biometric mode, the biometric controller 148 compares the digital representations of the physical features of the user's finger with a digital fingerprint representation such as the fingerprint data 112 stored in the memory 146. As explained above, the digital representation of the user's finger may be obtain as the finger is static on the finger contact surface 119 or as the finger moves across the finger contact surface 119. The biometric controller 148 then evaluates a level of similarity between the physical features of the user's finger and the digital fingerprint representation for fingerprint recognition.

In the navigation mode, the navigation controller 150 compares images of the user's finger, obtained at different times, to determine a movement of the user's finger relative to the TFT imager 106 over time. More specifically, the navigation controller may compare a new image with a prior image such as an image represented by the image data 113 stored in the memory 146.

While implementing either the biometric mode or the navigation mode, or when neither mode is being implemented, the switching engine 144 may be invoked to turn on and off the TFT imager 106, as explained above. In particular, the switching engine 144 may turn on the TFT imager 106 by application of a drive signal to the drive channel 128 of the TFT imager 106. Similarly, the switching engine 144 may turn off the TFT imager 106 by termination of the drive signal to the drive channel 128 of the TFT imager 106. Also, the switching engine 144 may turn on and off the illumination source 114, as explained above. In some embodiments, the switching engine 144 turns on the TFT imager 106 and the illumination source 114 in response to recognition of the user's finger within a detectable proximity of the TFT imager 106. Similarly, the switching engine 144 turns off the TFT imager 106 and the illumination source 114 in response to recognition of an absence of the user's finger within the detectable proximity of the TFT imager 106.

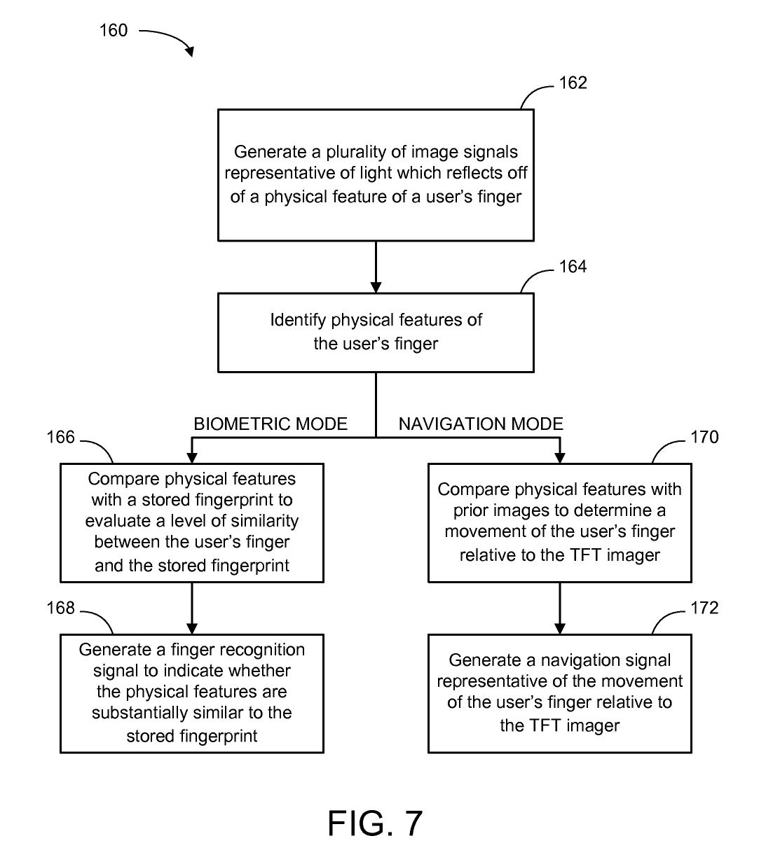

FIG. 7 depicts a schematic flow chart diagram of one embodiment of a method 160 for operating an optical input device which uses TFT imaging technology for both fingerprint recognition and finger navigation. Although the method 160 is described in conjunction with the imaging circuit 102 of FIG. 1, the method 160 may be implemented with other types of optical input devices.

At block 162, the TFT imager 106 generates a plurality of image signals representative of light which reflects off of a physical feature of a user's finger in contact with the finger contact surface 119 of the protective layer 124. At block 164, the imaging engine 142 of the integrated circuit 108 processes the image signals to generate and output an output signal based on a comparison of at least some of the image signals to other finger representation signals. The remaining operations of the depicted method 160 depend on which mode the integrated circuit 108 implements.

In the biometric mode, at block 166 the biometric controller 148 compares the physical features of the user's finger with a digital fingerprint representation to evaluate a level of similarity between the physical features of the user's finger and the digital fingerprint representation for fingerprint recognition. At block 168, the biometric controller 148 generates a finger recognition signal to indicate whether the physical features of the user's finger are substantially similar to the digital fingerprint representation. The depicted biometric mode then ends.

Alternatively, in the navigation mode, at block 170 the navigation controller 150 compares the physical features of the user's finger with a prior image of the user's finger to determine a movement of the user's finger relative to the TFT imager 106 for fingerprint navigation. At block 172, the navigation controller 150 generates one or more navigation signals representative of the movement of the user's finger relative to the TFT imager 106. The depicted navigation mode then ends.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. An optical input device comprising:
a thin-film transistor (TFT) imager comprising:
a protective layer comprising a finger contact surface;
a substrate; and
a TFT array of photo-sensitive thin-film transistors disposed on a surface of the substrate, between the substrate and the protective layer, wherein the TFT array is configured to generate image signals corresponding to physical features of a user's finger in contact with the finger contact surface of the protective layer; and
an integrated circuit (IC) coupled to the TFT imager, the integrated circuit to process the image signals from the TFT array.

2. The optical input device of claim 1, wherein the integrated circuit comprises an imaging engine to process the image signals from the TFT array and to generate digital representations of the physical features of the user's finger.

3. The optical input device of claim 2, wherein the imaging engine comprises a biometric controller with logic to compare the digital representations of the physical features of the user's finger with a digital fingerprint representation and to evaluate a level of similarity between the physical features of the user's finger and the digital fingerprint representation for fingerprint recognition.

4. The optical input device of claim 2, wherein the imaging engine comprises a navigation controller with logic to compare sequential images of the user's finger, obtained at different times, to determine a movement of the user's finger relative to the TFT imager over time.

5. The optical input device of claim 1, further comprising a signal communication channel between the thin-film transistors of the TFT array and the integrated circuit to transmit the image signals from the TFT array to the integrated circuit, wherein the integrated circuit is remotely located from the TFT array.

6. The optical input device of claim 5, wherein the integrated circuit is coupled to the surface of the substrate at a location distinct from a location of the TFT array on the surface of the substrate.

7. The optical input device of claim 1, further comprising an illumination source to emit light into the protective layer to internally illuminate the protective layer as a light guide, wherein:
the protective layer is substantially transparent;
the light internally reflects off of the finger contact surface according to total internal reflection (TIR) in an absence of the user's finger in contact with the finger contact surface of the protective layer; and
the light transmits through the finger contact surface and reflects off of the physical features of the user's finger and back through the protective layer toward the thin-film transistors in response to the user's finger in contact with the finger contact surface of the protective layer.

8. The optical input device of claim 1, wherein the integrated circuit comprises a switching engine to turn on and off the TFT imager, wherein the switching engine is configured to turn on the TFT imager by application of a drive signal to a drive channel of the TFT imager, and wherein the switching engine is configured to turn off the TFT imager by termination of the drive signal to the drive channel of the TFT imager.

9. The optical input device of claim 8, wherein the switching engine is further configured to turn on and off an illumination source to emit light into the protective layer to internally illuminate the protective layer as a light guide.

10. The optical input device of claim 9, wherein the switching engine is further configured to turn on the TFT imager and the illumination source in response to recognition of the user's finger within a detectable proximity of the TFT imager and to turn off the TFT imager and the illumination source in response to recognition of an absence of the user's finger within the detectable proximity of the TFT imager.

11. The optical input device of claim 8, further comprising a capacitive array of capacitive elements coupled to the TFT imager, wherein the capacitive array is configured to generate a sense signal in response to placement of the user's finger within a detectable proximity of the TFT imager.

12. The optical input device of claim 11, wherein the capacitive elements of the capacitive array comprise a drive element and a sense element, wherein the sense Is element is coupled to a single sense channel to transmit the sense signal from the capacitive array to the switching controller.

13. The optical input device of claim 12, wherein the switching controller is further configured to turn on the TFT imager in response to assertion of the sense signal above a threshold, and wherein the switching controller is further configured to turn off the TFT imager in response to deassertion of the sense signal below the threshold.

14. The optical input device of claim 1, wherein the thin-film transistors of the TFT array are arranged in a substantially rectangular shape to facilitate both optical fingerprint recognition and optical finger navigation using the same TFT array.

15. An electronic computing device with optical input functionality, the electrical computing device comprising:
a finger contact surface of a protective layer;
a thin-film transistor (TFT) imager aligned with the finger contact surface to generate images of at least a portion of a user's finger in contact with the finger contact surface; and
an integrated circuit (IC) coupled to the TFT imager and located remotely from the TFT imager such that a footprint of the integrated circuit does not overlap with a footprint of the TFT imager.

16. The electronic computing device of claim 15, wherein the integrated circuit is further configured to identify physical features of the user's finger, to compare the physical features of the user's finger with a digital fingerprint representation, and to evaluate a level of similarity between the physical features of the user's finger and the digital fingerprint representation for fingerprint recognition, wherein the integrated circuit is further configured to generate a fingerprint recognition signal indicative of whether the physical features of the user's finger are substantially similar to the digital fingerprint representation.

17. The electronic computing device of claim 15, wherein the integrated circuit is further configured to identify physical features of the user's finger, to compare the physical features of the user's finger with a prior image of the user's finger, and to determine a movement of the user's finger relative to the TFT imager for fingerprint navigation, wherein the integrated circuit is further configured to generate navigation signals representative of the movement of the user's finger relative to the TFT imager.

18. A method for operating an optical input device, the method comprising:
generating a plurality of image signals representative of light which reflects off of a physical feature of a user's finger in contact with a finger contact surface of a thin-film transistor (TFT) imager; and
processing the image signals to generate and output an output signal based on a comparison of at least some of the image signals to other finger representation signals.

19. The method of claim 18, further comprising:
identifying physical features of the user's finger;
comparing the physical features of the user's finger with a digital fingerprint representation to evaluate a level of similarity between the physical features of the user's finger and the digital fingerprint representation for fingerprint recognition; and
generating the output signal to indicate whether the physical features of the user's finger are substantially similar to the digital fingerprint representation, wherein the output signal comprises a fingerprint recognition signal.

20. The method of claim 18, further comprising:
identifying physical features of the user's finger;
comparing the physical features of the user's finger with a prior image of the user's finger to determine a movement of the user's finger relative to the TFT imager for fingerprint navigation; and
generating the output signal representative of the movement of the user's finger relative to the TFT imager, wherein the output signal comprises one or more navigation signals.
